(19) United States
(12) Patent Application Publication
(10) Pub. No.: US 2014/0278731 A1
(43) Pub. Date: Sep. 18, 2014

(54) System and Method for Agricultural Risk Management

(71) Applicant: Cresco Ag, LLC, Memphis, TN (US)

(72) Inventors: Terry Griffin, Memphis, TN (US); Clint Jayroe, Memphis, TN (US); Chism Craig, Memphis, TN (US); Barry Knight, Cleveland, MS (US); Charles Mitchell, Memphis, TN (US)

(21) Appl. No.: 13/833,792

(22) Filed: Mar. 15, 2013

(51) Int. Cl. G06Q 50/02; G06Q 10/06

(52) U.S. Cl. CPC G06Q 50/02; G06Q 10/0635
USPC 705/7.28

(57) ABSTRACT

A system and method for applying risk analysis to identify optimal crop varieties for use in a particular field with particular environmental characteristics and soil techniques is disclosed herein. The method adapts financial portfolio analysis methods for use with agricultural production to take into account the variability of soil, environment, and crop management. A system for supporting the use of the method is also disclosed.

### CROSS-REFERENCE TO RELATED APPLICATIONS

This application claims the benefit of U.S. Provisional Application No. 60/670,103, filed Jul. 10, 2012.

### FIELD OF THE INVENTION

The invention relates generally to portfolio analysis of agricultural products.

### BACKGROUND ART

The general principle of portfolio analysis is known in investment and financial applications. In those contexts, portfolio analysis allows a financial player to evaluate and hedge risk across the player's financial holdings as a whole, on the recognition that many financial products with higher potential payoff also carry higher potential losses. Stated differently, risk frequently accompanies potential reward, such that the financial products that carry the highest potential return on investment also carry the greatest risk of dramatic loss of principal. Principles of portfolio analysis seek to counterbalance riskier investments by including more stable investments in the portfolio as well. The result is that a portfolio may be stacked with products having varying degrees of risk in order to target a fairly predictable outcome range in terms of ultimate performance.

These principles have not been applied with any success to the field of agricultural production, or to data and decision making associated with farming. One reason is the absence of focus on this area, brought about in part from the incorrect assumption that agriculture is a low-tech industry. To the contrary, today's agricultural industry is increasingly high-tech—even more so than industry players realize. Additionally, fragmentation of the industry and the traditional privacy-centric viewpoint of industry participants create practical barriers to implementation of any robust analysis. Other barriers include cultural influences and inherent participant biases, such as the understandable unwillingness of farmers to share data and the typical unreliability of data projections made by industry players who have a vested interest in the outcome of the analysis. Moreover, issues inherent to agriculture prevent traditional analytic assumptions from being applied mutatis mutandis to the farming industry.

While each of these factors independently have prevented portfolio analysis from being applied to agricultural production industries (farming, orcharding, silviculture, pomology, olericulture, plantationing, other agricultural growing activities, and the like), this last impediment is perhaps the most problematic from a solution perspective. For example, in addition to the typical assumptions taken into account in financial theory, the variability in environmental characteristics and management techniques of agricultural fields stymie any attempt to apply a uniform theory without substantial accommodation. Unlike financial industries where a given stock will have the same performance characteristic in every portfolio in which it is found (e.g., it will generate, individually, the same performance return regardless of who holds it, how they hold it, or what else they hold), agricultural products are decidedly different. Environmental characteristics (some based on soil qualities, e.g., nutrient density, water holding capacity, depth of nutrients, texture, depth to impermeable layer, percent organic matter, structure, etc.; and others based on external environmental factors, such as rain, river flooding, sun exposure, temperature, etc.) and management techniques (tillage interval, formalized watering or fertilizing schemes, post-production burn, etc.) simply are not uniform. Therefore whereas a given stock behaves identically in any portfolio, an agricultural product will not perform the same on every field. In fact, environmental characteristics and management techniques vary not only by agricultural field and acre, but may vary wildly along any given footpath one might take across a single field, as depicted in FIG. 1, a graphical depiction of differences in soil conditions and management techniques (in this case, the use of pivot irrigation) across a single field. In all, the particulars of the industry have prevented traditional analysis from being actually—or even theoretically—applicable to the agricultural industry generally or farm-wide crop selection decisions specifically. Such application has not been possible with traditional tools and traditional thought processes.

Nevertheless, there is a need to apply portfolio analysis to agricultural data and decision making. With analysis, a farmer might improve his or her balance of risk and potential yield by selecting a portfolio of seeds or other crop inputs to plant or apply in a given year, on a particular schedule, or at given locations in his or her field(s). Given the right portfolio of products, as growing conditions in a given year lead to lower yield in one variety, strong performance from another variety might offset some of the realized risk, providing balance and predictability to overall yield and expectations.

### SUMMARY OF THE INVENTION

Needs as described above, as well as others, are addressed by various embodiments of the methods, systems, and devices provided in this disclosure; although it is to be understood that not every embodiment disclosed will address a given need.

The invention discussed herein involves the application of portfolio analysis processes to various forms of agricultural production. As described in greater detail, embodiments may take into account the variability of environmental characteristics and management techniques, and apply to them an aggregated array of data selected from sources such as public data, field trials, vendor data, and observed commercial production data collected from growers. Preferably the data is gathered and maintained in a manner that is indifferent to outcomes and expectations. Working with knowledge of the particularized environmental characteristics and management techniques involved for a particular grower, the aggregated data is applied in the current methodology to create a custom-tailored prescription plan for a grower that takes into account not only the grower's risk tolerance as in traditional portfolio analysis, but also the unique circumstances of the grower's environmental characteristics and management techniques. In some embodiments the methodology involves grouping growers with similar environmental characteristics and/or management techniques, and at the point of calculation limiting the data considered to, or giving greater weight to, data that originated from that group of growers or from environmental characteristics and/or management techniques involving the same or a similar paradigm.

One embodiment disclosed is a process for providing benefits such as those discussed above, while maintaining confidentiality in a manner that traditional analytics could not do.

The foregoing presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### DESCRIPTION OF THE FIGURES

FIG. 1 shows a field map exemplifying the variance in management techniques that may be exhibited across an agricultural field.

FIG. 2 shows an exemplary process for determining risk for a portfolio of agricultural products according to one embodiment of the disclosure.

FIG. 3 shows exemplary data that may be used or reported in connection with the teaching of the present disclosure, in this case, the yield per acre rate determined from actual production and harvest data drawn from observational reports across 70,000 acres of soybean fields planted with 31 different soybean varieties.

FIG. 4 shows a graph based on the information that underlies the chart shown in FIG. 3, depicting the average output (means) and covariances between all bundle combinations of products.

FIG. 5 displays, with reference to FIG. 3, the depicted Grower 2's selected soybean varieties and the percentage of total crop acreage planted, plotted against average yield versus risk.

FIG. 6 depicts a process for performing the regression analysis and mathematical optimization on an agricultural portfolio, according to one embodiment of the disclosure.

FIG. 7 is an alternate view of information in a similar scenario, as the same may be output in connection with the teachings of the present disclosure.

FIG. 8A shows an exemplary report showing benchmarking results using an embodiment of the current disclosure.

FIG. 8B shows another exemplary report showing benchmarking results using an embodiment of the current disclosure.

FIG. 9 shows a diagram of an exemplary arrangement of databases and data flow in an embodiment of the present disclosure.

### DETAILED DESCRIPTION

### A. Definitions

With reference to the use of the word(s) “comprise” or “comprises” or “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and/or the following claims.

The term “agricultural production” refers to any one or more of farming, orcharding, silviculture, pomology, olericulture, plantationing, other product-growing or product-harvesting endeavors in the nature of agriculture, or the like.

The term “about” as used herein refers to a value that may vary within the range of expected error inherent in typical measurement techniques known in the art.

The term “storage device” as used herein refers to a machine-readable device that retains data that can be read by mechanical, optical, or electronic means, for example by a computer. Such devices are sometimes referred to as “memory,” although as used herein a machine-readable data storage device cannot comprise a human mind in whole or in part, including human memory. A storage device may be classified as primary, secondary, tertiary, or off-line storage. Examples of a storage device that is primary storage include the register of a central processing unit, the cache of a central processing unit, and random-access memory (RAM) that is accessible to a central processing unit via a memory bus (generally comprising an address bus and a data bus). Primary storage is generally volatile memory, which has the advantage of being rapidly accessible. A storage device that is secondary storage is not directly accessible to the central processing unit, but is accessible to the central processing unit via an input/output channel. Examples of a storage device that is secondary storage include a mass storage device, such as a magnetic hard disk, an optical disk, a drum drive, flash memory, a floppy disk, a magnetic tape, an optical tape, a paper tape, and a plurality of punch cards. A storage device that is tertiary storage is not connected to the central processing unit until it is needed, generally accessed robotically. Examples of a storage device that is tertiary storage may be any storage device that is suitable for secondary storage, but configured such that it is not constantly connected to the central processing unit. A storage device that is off-line storage is not connected to the central processing unit, and does not become so connected without human intervention. Examples of a storage device that is off-line storage may be any storage device that is suitable for secondary storage, but configured such that it is not constantly connected to the central processing unit, and does not become so connected without human intervention. Secondary, tertiary, and offline storage are generally non-volatile, which has the advantage of requiring no source of electrical current to maintain the recorded information.

A storage device cannot be construed to be a mere signal, although information may be communicated to and from a storage device via a signal.

The term “telecommunications network” as used herein refers to a network capable of transferring information spatially by conducting signals, such as but not limited to electrical or optical signals. The network itself cannot be construed to be a mere signal. The “optical” signal need not comprise radiation in an optically visible wavelength, and may be in any suitable wavelength. The network may be a packet-switched network (such as a local area network or the Internet) or a circuit-switched network (such as some telephone networks or the global system for mobile communications (GSM)). Information sent via a packet-switched network may be for example electronic mail, an SMS text message, and a digital file sent via file transfer protocol (FTP). Information sent via a circuit-switched network may be for example a voice mail message, a facsimile message, an SMS text message, or a digital file.

The term “processor” or “central processing unit” (CPU) as used herein refers to a software execution device capable of executing a sequence of instructions (“program”). The CPU comprises an arithmetic logic unit, and may further comprise one or both of a register and cache memory.

The term “variable” as used herein refers to a symbolic name corresponding to a value stored at a given memory address on a data storage device (although this address may change). The value may represent information of many types, such as integers, real numbers, Boolean values, characters, and strings, as is understood in the art. As used herein the value of a variable is always stored in a data storage device, and shall not be construed to refer to information only stored in a human mind. Any recitation of a variable implicitly requires the use of a data storage device.

The term “machine-readable format” as used herein refers to a medium of storing information that is configured to be read by a machine. Such formats include magnetic media, optical media, and paper media (punch cards, paper tape, etc.). Printed writing in a human language, if not intended or configured to be read by a machine, is not considered a machine readable format. In no case shall a human mind be construed as “machine readable format.”

The term “database” as used herein refers to an organized data structure comprising a plurality of records stored in machine-readable format.

### B. Processes

A process is provided for data management and manipulation for use in portfolio analysis for agricultural production business. The process is implemented by various embodiments of the system described in Part C and on storage devices capable of being read by a machine. In an example embodiment, the process includes:
Identifying 100 a data contributor who has access to information about agricultural production, or about factors that do or may influence agricultural production;
collecting 102 data from at least one data contributor and from a plurality of source types about agricultural production or factors that do or may influence agricultural production, in which at least one of the source types comprises observational data about inputs and results from commercial production efforts, and in which at least one other of the source types comprises public data such as information from studies conducted by universities or government entities;
tagging 104 data with an indication of the source of such data;
identifying 106 types of information that are to be treated as personal;
creating 108 a master database and a plurality of feeder databases;
associating 110 at least one feeder database with a contributor through whom at least some of the collected data is received;
maintaining 112 the data collected from the contributor in the feeder database associated with the contributor;
providing 112 the contributor with access to the database associated with the contributor;
linking 114 a plurality of feeder databases to the master database, in a manner such that a subset of information added to the feeder database populates forward into the master database, wherein the subset of information comprises the indication of source type of the data in the subset, information about environmental characteristics of geographical areas regarding which data is present in the subset, and information about management techniques of geographical areas regarding which data is present in the subset, and wherein further the subset does not include information to be treated as personal;
receiving 116 a request for data analysis from a requestor associated with a first entity engaged in agricultural production, about which first entity at least some observational data from such first entity's prior agricultural production efforts is contained in a feeder database;
receiving 118 a plurality of inputs from the requestor, said plurality of inputs comprising at least a crop to be analyzed, a yield goal, and afield having defined soil characteristics;
querying 120 the master database to identify other entities for whom data in the master database reflects environmental characteristics and management techniques similar to those reflected in information associated with the first entity to create a group called a cohort;
determining 122 whether the population of other entities is so small that the sample size results in high chance of error or is otherwise statistically uncertain or insignificant, or that reporting results in response to the query would reveal enough information to a person familiar with the other entities that personal information could be derived from or concluded with a high level of certainty from results that may be reported; and if so, either broadening the scope of environmental characteristics or management techniques deemed similar for purposes of analysis, whereby the number of other entities is increased; or requesting a new request for data analysis with broader parameters;
analyzing 124 the information from the subset of data from the master database associated with the first entity and the other entities in connection with the request for data analysis, to determine an optimal crop variety (or cultivar) bundle for use in the field;
removing 126 from the optimal bundle any crop variety for which the amount of seed used or distributed is below a minimum amount, and reallocating acreage or seed amounts for such de minimis products to crop varieties remaining in the bundle;
allocating 128 the crop varieties within the optimal bundle according to seed maturity groups;
displaying 130 the resulting optimal crop variety bundle and a risk curve depicting various yield possibilities and corresponding risk to the first entity;
adding 132, to the feeder database that contains observational data about such first entity, information related to the result; and
reporting 134 the request to the first contributor or the requestor associated with such feeder database.

Other embodiments may perform only some of the steps outlined above, or may collect data or produce analyses that rely on more or fewer source types or contributors. For example, in the collecting data step, the source types relied upon may be limited to observed commercial production data. As a further example, statistical weight may be placed on or discounted from certain types of data during a portfolio analysis to agricultural production business. In an example embodiment, the process includes some or all of the features of the embodiment discussed above, and further involves analysis wherein a higher significance is placed on information from the first entity and the other entities than other information. Alternately or together with this embodiment, the analysis may place a higher significance on information from source types including observational data than other source types. Also alternately or together with the above, greater weight may be placed on observed commercial production data more proximate to the location of the field-in-interest, while less weight is given to observed commercial production data taken at longer distances from the field-in interest. In most cases, the analysis is to be conducted without regard to an expected outcome, such as a favored product ranking high in any results.

Financial portfolio analyses may include developing a value of the portfolio-holder's risk tolerance, such as by asking the portfolio holder to subjectively report his or her own opinion of his risk tolerance, or by putting the portfolio-holder through a series of questions or tests to evaluate what his or her risk tolerance may be, or otherwise evaluating the portfolio-holder's likely risk tolerance. While some embodiments of the present invention may allow a grower (the “first entity” described above) to input a risk-tolerance level at the outset, the inventors consider that self-reporting and other techniques for determining an individual's risk tolerance level are of suspect utility, given that growers tend to mischaracterize their own level of risk acceptance, at least in connection with agricultural production; a vast majority of growers will identify themselves as risk-averse, which would be expected in an industry that is known for its conservative business principles and unpredictable boom-and-bust cycles. Yet their very participation in such an unpredictable industry belies growers' self-judgment as risk-averse. Such situations present an obstacle to using traditional portfolio analysis principles, where the portfolio is created based on the risk acceptable to the owner. Thus, in contrast with such typical treatment in financial services, the analysis disclosed herein might be conducted so as to avoid relying on or taking into account in the first instance an individual risk tolerance factor associated with the grower. In one particular embodiment, the grower may be asked to define a yield target for his or her particular commodity, and the process will analyze the optimal bundle and characterize the associated risk. The system may then receive further inputs from the grower, such as selecting particular crop varieties to be used or avoided, or altering the yield goal, environmental characteristics, or management techniques, and the system will display a new crop variety bundle meeting the revised inputs and display the associated risk.

In an alternative embodiment, the analysis is conducted without including a value for the grower's subjective or detected risk in the calculations at all. In this or another embodiment, the results output from the analysis might identify a level of risk associated with the option or options so presented, rather than limiting the calculation of the options based on a presumed (but likely incomplete or incorrect) risk tolerance level associated with the grower. In this manner, the portfolio-holder may be allowed to select or accept an option, or seek alternate calculation of options, with knowledge of a risk indicator while avoiding the potential difficulties associated with self-reporting or otherwise divining a risk tolerance level.

In some embodiments, the above would be particularly tailored to maintaining confidentiality and privacy of the information collected from growers, based on the maintenance of separate databases and populating forward into the master database of only information that is deemed not to be personal. Such an embodiment might include placing access and security level control in the hands of the contributor, rather than the one that controls the master database (recognizing that in many cases at least some level of access or control of the feeder database by the one who controls the master database would be appropriate, at least for configuration and coordination purposes).

For a fuller understanding, it is noted that prior to application of the disclosures taught herein, data related to agricultural production businesses is typically disparate, uncoordinated, and ultimately unintelligible for any planning purposes. Yield information and other data necessary for interpretive analysis across individual fields and farms typically does not exist in a single database, making analysis impossible. Even where data is collated, meaningful application is elusive, as seen from FIG. 3, which shows the yield per acre for rate determined from actual production and harvest data drawn from observational reports across 70,000 acres of soybean fields planted with 31 different soybean varieties. As will be apparent, the yields plotted on the graph have no apparent trend discernible by a grower. The inventors believe that when faced with a data set like that shown in FIG. 3, most growers trying to use the data for future planting decisions would intuitively select a variety plotted high on the chart.

Borrowing, in part and with modification, terminology from financial portfolio management, what is needed are methodology and tools for identifying an “efficient frontier” for varieties to be planted and/or products to be applied. For simplicity at this point in the disclosure, we set aside for the moment the complexity introduced by the variance in environmental characteristics and management techniques, which must be addressed in ways beyond the grasp of financial theory and traditional portfolio methodology and which this disclosure solves later. Setting aside such complexities for the moment, FIG. 4 shows a graph based on the same input information depicting the average output (means) and covariances between all bundle combinations of products.

Traditional financial tools would use a mean-variance framework which minimizes total covariance risk to each given level of output, where the means and covariances were readily calculated and available. Analyzing agricultural production scenarios introduces special problems that have previously not been recognized or solved. By way of example, in an agricultural production environment extraneous factors introduced by the variance discussed above will typically render the means and covariances not readily calculated or available as is required in the traditional financial teachings. The present disclosure addresses the fact that to build a mean-variance model for an agricultural system, some or all of such extraneous factors should be held constant such that the means and covariances can be computed, by holding other factors constant. These other factors comprise the first entity's combined management techniques for the field in question and a priori environmental characteristics (e.g., soil qualities) or induced environmental characteristics, said combination referred to as a “regime.” (As will be discussed later, this regime can be used to customize the data set and analyses performed for a particular field.) Therefore, specific information regarding the contributor must be collected and passed to the estimation and optimization steps of the analysis so that the means and covariances can be calculated in the estimation step and the efficient frontier can be determined in the optimization step.

Using the analysis visually represented by FIG. 4, individual farms and products can be evaluated against the potential possibilities curve (the efficient frontier) to show how a more efficient bundle of products can increase expected output (means), lower realized risk, or both. In the chart, each circle 2 represents the average yield and risk associated with obtaining that yield with a particular variety. Varieties that appear to the upper right 2a have high potential yields but also have correspondingly high associated risk. As shown, the boxes 4a and 4b represent the portfolio of varieties actually chosen by each of two growers, Grower 1 (depicted by box 4a) and Grower 2 (depicted by box 4b). Both growers achieved similar yields (roughly 48 bushels/acre, as indicated by dashed line 6), but Grower 2 (unwittingly) undertook almost twice the risk in getting to that result. The curve 8 to the upper left shows the efficient frontier drawn with respect to 7500 possible combinations of soybean varieties based on yield goal and risk preference. The efficient frontier provides the least risky combinations to achieve a particular yield rate. Making decisions in light of the curve would allow Growers 1 and 2 to manage their risk while maximizing potential return without undertaking undesired risk levels.

FIG. 5 displays grower 2's yield rate 4b plotted against the risk associated with the selected soybean varieties 2 and the percentage of total crop acreage planted in each variety 3. While Grower 2 obtained a similar yield per acre to grower 1 as shown in FIG. 4, grower 2 relied on relatively riskier crop varieties, for which minute changes in environmental factors or management techniques may dramatically decrease (or increase) the yield the next year. Grower 2 may be satisfied with this risk level, or he may opt to find a mix of crop varieties that produce a similar yield result with more predictability. Grower 2 may select predictable yields at lower risk by choosing a combination of products that approach the efficient frontier 8.

As noted above, application of financial theory and methodology to agricultural production is not possible without substantial additional effort and revision, due in part to the variance in environmental characteristics and management techniques, which are not issues in financial theory. The present disclosure teaches, inter alia, a resolution for this problem.

Central to any reliable analysis is data collection. Preferably the data is gathered and maintained in a manner that is indifferent to outcomes and expectations. That is, the data is collected and kept regardless of the implications such data may have for a particular agricultural product or for a particular environmental scenario or technique application. Data may be indexed against its source to identify whether the source is grower-originated, observed commercial production data (which presumably may have advantages in terms of being unbiased and derived from actual production scenarios), field trials (which may have advantages due to robust controls and observations, but which also may be suspect for those very same reasons), vendor data (which may include additional details regarding intended application and proposed best case expectations), or public sources such as university or government studies. Any type of data may be entered into the system.

In some embodiments, contributors will have the option of validating data to ensure its accuracy prior to uploading to the master database. Furthermore, either before exporting to the master database or before performing a portfolio analysis, the system may scan the data and remove sets containing clearly inconsistent information (e.g., a non-existent crop variety) or outlier data that is clearly unlikely (e.g., a yield rate that is 300% greater than the next highest yield rate). A person of ordinary skill in the art would understand that other routines and methods for identifying outlying or patently inaccurate data sets could be used without departing from the scope of this disclosure. Data integrity is therefore maintained.

Aside from such data cleansing efforts based on statistically-sound or otherwise proven unbiased techniques for addressing data integrity, data input into the system is maintained for use in any calculation. Stated differently, any weighting of the data for statistical significance or reliability is done at the calculation end, rather than at the point of exclusion from the database. For example, the method may give greater weight when actually running portfolio analysis calculations to (1) particular sources of data (e.g., observed commercial production data weighted more significantly than vendor “optimal yield” data); (2) the proximity of observed commercial production data to the field-of-interest (on the theory that fields adjacent to or near the field-of-interest will share more environmental characteristics than fields of greater distance from the field-of-interest); or (3) data sets relating to crop seasons that had a “typical” or average yield rather than crop seasons for which yield was abnormally high or abnormally low. One advantage of this methodology is that it allows data to “mature” in the system as additional data of the same type or of context or other characterization is collected. Certainly, the original data will not change, but that original data at one point in time may be considered too sparse or otherwise subject to bias for inclusion in a calculation, yet after additional data is collected the original data may be desirous for inclusion. For example, when the database is first populated, it may have data provided by only a single vendor. In order to avoid potential bias, that single-vendor provided data may be excluded from calculations until a population of vendors have input data in number deemed sufficient to offset any bias. The method can also be applied to other sourcing factors, or to data characteristics other than source. For example, when a database in a particular county is originally populated, it may have data contributed by only one or a few growers. In order to prevent the reports from revealing information about a particular grower to others, the system may be configured to refuse running a calculation or report based on a geographical limitation (such as the county) until the population of grower-sources in the database is deemed sufficient to obfuscate the particular source to which any given data can be attributed.

Attention must also be given to maintaining confidentiality of the portions of data that growers may deem to be personal. This typically involves inherently-personal information such as the grower's name, address, account name with vendors, telephone number, and physical or e-mail addresses. The inventors deal with confidentiality by treating this type of information specially, and configuring the methodology to leave this data in databases most closely tied to the grower. Specifically in one embodiment, multiple databases are established. First, a database is established at the level of the grower, advisor, vendor, or other contributor that brings data about the grower to the system. Frequently, this may be a trusted advisor that deals with multiple growers, such as a crop consultant or an agricultural retail sales and services provider (“retailer”). Such consultants and retailers often may benefit from analysis of their clientele growers' actual inputs (e.g., varieties planted, fertilizers, soil amendments, water, herbicides, defoliants, nutrients, other items “input” to the soil or otherwise “input” to the agricultural production efforts), alternatives, and management techniques (such as tillage, row spacing, etc.)) in helping them to best advise the grower. With the incredible variability among environmental characteristics and management techniques, as well as the vast array of possible input permutations, such analysis is well beyond the capacity of any person or group of persons with traditional pen-and-paper analysis. In an embodiment taught herein, the problem is solved by a method staging multiple databases that interconnect with one another.

With respect to information classified as personal, the information is populated into only the database(s) most closely associated with the grower. For example, the personal information is populated directly into the database that is accessible to the contributor who originally inputs the data, whether that contributor is the grower, a consultant, etc. This database, called a feeder database for simplicity, is accessible (at least in part) to the contributor so that the contributor can view and perform its own analysis with data contained therein. Where the number of fields or acres contributed warrants, the feeder database would have data related to multiple fields, acres, and/or growers. In some cases, the contributor may also have access to data from other entities that themselves could be, or in the future might be, contributors. For example, a trusted advisor who contributes information from various growers that use the advisor's services may also work with crop consultants. Such crop consultants would also represent various growers, and may have information that can be populated into the same or a different feeder database, depending on the size of the consultant's grower clientele. As a different example, the advisor as a contributor may have access to data source types other than the growers' data, such as trials and even third-party-sourced data like government, university, or privately-held data sets. In each case, the entity that contributes this information to the feeder database is considered the contributor, even if that contributor relies on underlying sources. In this example embodiment, it is considered that the contributor either generates the data, or has some relationship of trust with the underlying source.

In this manner, the following people may be associated with entering or controlling data related to a grower (or first entity). A contributor may be the grower himself, or the contributor may be a crop consultant, sales representative of a retailer, or other agent of the grower. A person may request an analysis to be performed by the system. Again, this requestor may be the grower himself, or a crop consultant, retailer sales representative, or other agent. Additionally, a seed vendor may contribute information related to the first entity and may request a production analysis, particularly in scenarios in which the vendor is conducting trials for seed and variety testing and evaluation and has contracted with the grower to assist in those trials.

The personal information is available to the contributor, and the contributor may have need to reference that personal information in connection with fulfilling its role. On the other hand, the contributor or the sources may not want to extend the trust so far as to place the personal data in a database that is not closely associated with the contributor. In this embodiment, the feeder database associated with each contributor is connected to a master database that spans information contributed by multiple contributors. The master database is linked to the feeder databases in such a way that information populated into a feeder database is uploaded into the master database. However, some of the fields in the feeder database are not populated forward to the master database, or are forwarded only with modification. For example, the fields containing personal information may be excluded from any data forwarding, such that they do not appear in the master database at all. In other cases, for example, data in the fields containing such information may be replaced by indexing values, aliases, or other data that is not considered personal. By way of example, a grower's name may appear in a feeder database, but in the master database any equivalent field may have a numeric identifier instead.

Another feature of the described methodology is the attention to avoiding disclosure of analytic results that may lead to ready identification of a grower, where such identification is not required. For example, if it is known that only one grower in a particular county or zip code grows cherimoya, a report run by a different grower on cherimoya productivity and inputs in that county or zip code would naturally reveal the identity of the sole cherimoya grower. To deal with this, some embodiments will include within the method a step of checking the scope of the request against the number of growers taken into account in the analysis. Where the number of growers to be considered is below a predetermined threshold, the method would either demand a wider scope of inquiry, or would itself broaden the factors under consideration until the number of growers is appropriate. Alternately, the analysis might simply be refused.

As noted above, one of the problems with applying financial theory to agricultural production is the massive variation among environments and circumstances in which agricultural inputs are applied. This variation, such as in environmental characteristics and management techniques, means that a given crop variety may perform entirely differently in one grower's portfolio than it would in a different grower's. The present disclosure deals with this situation by taking into account that variation, and identifying groups of growers that have similar environmental characteristics and/or management techniques (e.g., similar soil characteristics and/or treatment characteristics). These groups of growers for convenience may be called “cohorts,” and data related to the group of growers within the cohort may be known as a “cohort subset.” The system may involve predetermined cohorts; alternatively, a custom cohort may be selected by drawing upon data from growers facing regimes similar to the regime in play for the particular field or grower for which the portfolio analysis is being performed. For example, in one embodiment, a soil index is created to classify soils along a spectrum. The various fields and land segments of a grower are then associated with the relevant value in the soil characteristic. Growers, even those in remote geographic locations, can be evaluated as similar or dissimilar in respect of the soil index. Similarly, record may be made of management techniques (e.g., whether external irrigation is or may be applied), again for purposes of comparing the environmental differences of growers. In the embodiment under discussion, the analysis takes into account similarity of growers. These growers would form a custom cohort based on the selected similarities to be analyzed. Thus, a query from one grower would then be answered by analyzing information derived from growers in the same cohort. It should be noted that the grouping into cohorts need not occur before the time of analysis of a request from a grower. Rather, because the master database is constantly evolving with new information, the master database may be evaluated at the time of each request to identify the relevant paradigms and relevant cohorts. The ability of the disclosed system to evaluate management techniques is notable, and is believed to improve the accuracy of the portfolio analysis by taking into account a wider array of variables that alter the productivity of a field.

Another of the problems addressed by the current disclosure is the issue of bias and reliability. Many prior approaches to analysis in the agricultural production field have included marketing materials that are generated by vendors of the crop species shown as most favorable in the material. It is suspected by many in the industry that an untold story of data filtering may be behind these results. In contrast to such practices, the current disclosure contemplates the inclusion of all data from all contributor sources, both into the feeder databases, and, subject to appropriate filtering only for personal data, the master database. Data is not first vetted for whether it would tend to support a given product or result, but is taken in as received (subject to the routines discussed above for identifying wildly inconsistent or patently inaccurate data). This allows the feeder databases to be used for accurate historical trending of information relevant to a contributor's business, and for the master database to include an ever-growing population of unfiltered data. While the value of single farm data is finite to that grower, the greatest value for each individual grower occurs in pooled community analysis. An advantage of this approach is that data may, by virtue of combination in the aggregate with other data from other sources over time, become more reliable. For example, if the databases originally include data from a single vendor, at that time the data may be suspect for bias. However, once additional vendors' data populates into the databases, including that from observational sources associated with reports from growers (i.e., information not entirely within any vendors' control), the bias can be overshadowed by aggregate considerations.

Of course, it may be appropriate to account for differences in reliability of data when analysis is run. This is handled in the described methodology, not by eliminating data from the databases, but by keeping that data in the databases and weighting data by source as appropriate. In some cases, data from manufacturer sources will be deemed the least reliable, and therefore will be given a fractional consideration. In almost all cases, it is contemplated that once a sufficient population of data is present in the system observed from commercial production sources (e.g., information reporting results of growers' harvests) that observational data will be the most reliable. Accordingly, in some embodiments the observational data will be weighted to have a greater effect on the outcome of the analysis.

It also will be desirable to allow an entity who makes a request for analysis to specify which sources it desires to have queried. Maintaining in the master database the entirety of the contributed data set, with information tagged by source type, allows this preference selection to be accommodated. With the full information available in the database, the requestor may choose to have the method performed while excluding consideration of, for example, manufacturer-contributed data while including other types of data.

The described method also in many embodiments defeats bias by providing that the data populated into the master database is from as many source types as is possible. As noted, the source type believed to be most reliable is historical information derived from observational data of inputs, environmental characteristics, management techniques, and harvest information. Ideally, this observational data will comprise a substantial portion of the information in the master database. Other source types should also be represented, where appropriate, including vendor-provided data, information from field trials, information from university studies, and information from government studies and databases. A preferred embodiment would involve data from all of these source types, or at least a plurality of source types, in the master database. Where data from a plurality of source types is present, at least one of those source types should be observational data. In one embodiment of the method, the presence of observational data in the database is ensured by providing that requests for analysis must be associated with an entity that actually has observational data within a feeder database. This both incentivizes increased submission of data to the system for analysis, improving the reliability of results, and acts as a guard against a free-riding system in which observational data may be lacking. Using such a methodology means that the more the system is used, the more reliable it becomes. As the community of data and users becomes larger (more fields, varieties, and overall number of observations), the more powerful the master database and its use. Powerfully, multiyear on-farm data can be used to populate predictive models to help farmers mitigate risks and improve profitability.

Within the data from these various source types might identify or include (without limitation) the following data: crop year, commodity, soil type, soil texture, crop variety or hybrid, planting date, row configuration, plant population, row spacing, irrigation type, field boundaries, seed treatments, tillage practice, crop protection, plant canopy temperature, atmospheric temperature, rainfall, pesticide applications, fungicide applications, and/or fertilizer applications.

Once the master database has been populated and a subset of data has been created based on the users' cohort and regimes, the grower's data is analyzed against the cohort to produce an optimal bundle of crop varieties, as described first in a general manner, and then more specifically below. The data is analyzed to determine the means and covariances. Means for the cohort are calculated in the traditional way, that is, the averages are calculated or estimated in the statistical sense. The covariances are calculated for the entire system (or subset of data) as well as for each pair of variables specified in the cohort regime. The means and covariances are then used to determine the bundle of products that minimizes covariance risk for a given level of output (e.g. yield, returns, profits, etc.). A yield goal can be specified by the user for the analytics in this step to optimize a bundle of crop varieties to meet this yield goal with the minimal amount of covariance risk. An extension of the yield goal option is to evaluate the optimal bundle of crop varieties for a sequence of output levels that form the “efficient frontier.”

Now describing the analysis in more detail, and as illustrated in FIG. 6, an analysis using mathematical optimization techniques calculates the optimal bundle of crop varieties. In 200, a database is populated with information concerning various crop varieties, yield rates, and explanatory variables such as environmental characteristics and management techniques, as further described above. In 202, inputs are received from the user, such as a designated field or soil type, crop type, intended yield goal, and other information as described below.

In one embodiment, and as depicted shown in 204, after a series of characteristics specified by the user is received, a cohort is created for use in the analysis. The base regression analysis equation is y=Xβ+ε where y is an n×1 vector of dependent observations on crop yield, farm profitability or some other output metric, X is an n×k matrix of explanatory variables (such as individual environmental characteristics or management techniques) in the cohort, β is a k×1 vector of estimated coefficients and ε is an n×1 vector of residuals; where n is the number of observations and k is the number of explanatory variables. The composition of X includes the variable-of-interest, such as the crop variety or management decision that the user would select, plus all the explanatory variables which comprise other input use (e.g., fertilizer, fungicides, insecticides, irrigation), cultural practices (e.g., tillage, planting date), and environmental factors (e.g., soils, weather). As an example of a simple statistical model, crop yield could be regressed against variety (as the variable-of-interest) and soils. Based on the user's input, soils may be removed from or included in the list of explanatory variables. Other variables, such as presence of fungicide applied, planting date, cumulative rainfall in specific time intervals, etc., may be added. The particular specification of the regression model (that is, the composition of the X matrix and E vector) is dynamic and potentially differs for each user-initiated run of the risk analysis tool.

The calculated mean and covariances are then entered into an optimization analysis that determines the bundle of products that minimize risk for a given level of output, such as a stated yield goal. The user's basic characteristics are populated into the analytics based on a priori information derived from field information (e.g., soils, irrigation types, cropping systems, etc.) while further characteristics and management scenarios are populated by user's input during interaction with user-interface, as described above. A multitude of optimization techniques can be used such as linear programming, quadratic programming, mixed integer programming and so forth, without departing from the scope of this invention, For example, in some embodiments, the optimization analysis may take the form of identifying the Sharpe ratio of the resulting design curve when assuming that the risk free rate of return (or risk free asset) is zero, and then determining the correlating yield and risk for that Sharpe ratio.

In some embodiments, and as shown in 204, the optimization analysis may first produce an “unconstrained” run, which includes all the data for the subset of the master database with no constraints (or only nominal constraints, such as the type of crop and the field being planted) being imposed by the user. A user could choose to impose constraints, such as deselecting available products or vendors, specifying a maximum number of products to apply, a yield goal, etc. The result of this unconstrained run is displayed 206 to the user. In some embodiments and as shown in FIG. 7, the display to the user may show the efficient frontier 8 with an expected yield 10 and variance 12. The type and amount of crop varieties 16 may also be displayed. Finally, a risk tolerance indicator 14 shows the user the level of risk associated with meeting the originally inputted yield amount. Other information (such as useful crop management technique or environmental characteristics needed to attain the yield amount, recommended substitute crop varieties, second- or third-best mixes, or other information a grower may find useful for planting) could also be displayed.

The user may perform additional model runs after viewing the unconstrained run output and, in 208, select or deselect a plurality of environmental characteristics, management techniques, crop constraints, or other input constraints. A new run of the model is conducted 210 and displayed to the user 212, who may then further revise the input constraints. Such user-specified characteristics are received from the user in the form of parameters that will define the matrix and vectors in the regression model as well as instruct the regression analytics how to interpret each run.

More complex optimization and parameter definitions may also be employed. For example, in some embodiments a minimum acreage “floor” may be provided, such that if a product is to be included in a portfolio produced for a user, the product will be used in an amount at least as large as the floor acreage. This is a variation from traditional financial portfolio analysis, which allows a portfolio to include arbitrarily small investments in particular stocks, bonds, securities and the like. Rather, in agriculture, it is preferred that a manageable amount of a particular product (or a manageable area sown with the seed of that product) be used. Accordingly, a floor is included to provide a cut-off amount, below which additional products will not be included in the portfolio. In some embodiments, this floor is set at 40 acres.

Another agriculture-specific optimization tool in some embodiments includes the ability to spread seed allocations across a variety of maturity groups in order to reduce risk. A grower typically has multiple fields and cannot sow all fields at the same time given limited equipment and other resources. Furthermore, weather conditions may delay planting or harvesting. This contrasts with typical financial products, which may be bought and sold at any given time or simultaneously, and for which the only resource restriction is the amount of money available for making purchases. Because growers must plant and harvest over a period of days and weeks, the risk-averse grower will allocate seed according to maturity groups, which are staged sets of seeds and crops planted at roughly the same time. In some embodiments, the portfolio risk analysis will distribute selected products or cultivars across maturity groups to provide the optimal risk allocation.

The method and analysis herein can also be applied to benchmarking, giving a grower (or a consultant or other entity working with a grower) the ability to see how his or her agricultural production compares with others generally or with those that are similarly situated. This, in turn, can be used as an educational tool, or as a trailing indicator in order to improve future decisions. In other cases it may be useful to validate prior decisions or methodology, or to show a track record regarding risk taken or typical return on investment, such as for future decisions related to financing. Data can also be used to benchmark farmers within peer groups to help improve efficiency and profitability. Such benchmarking capabilities are depicted in FIGS. 8A and 8B.

Historical and current data are therefore used to populate predictive models, to assist growers and others in the agricultural production industries.

### C. Systems

Systems for providing portfolio analysis pertaining to agricultural production efforts are provided. The system disclosed herein, and embodiments containing some or all of the components herein described, performs the processes described in Section B. As depicted in FIG. 9, the system has the following components.
First, there is at least one feeder database 30 having data related to or identifying some or all of the following information: (a) observational data, which may include grower personal information; (field location, size, and environmental characteristics (e.g., soil regime, climate conditions, weather conditions, and the like); management techniques (e.g., tillage, irrigation type and amount, fertilizers applied, insecticides applied, and the like); plant variety and yield data; and plant status characteristics (e.g., planting dates, canopy temperatures, insect infestations, and the like); (b) vendor or retailer sales and research information, and results of field trials; and (c) publicly available information, such results of university field trials and government published reports and databases. Feeder databases 30 may be associated with particular retailers, crop consultants, vendors, publicly available data, and other source types.
The feeder databases 30 are linked with a master database 36 in such a manner that a subset of information is periodically exported from the feeder databases into the master database. This subset may include the various types of information included in the feeder databases, but it should not include personal information, which either is not exported into the master database or is replaced by indexing values, aliases, or other information not considered personal. In this manner, the confidentiality concerns discussed with respect to the processes above are addressed by the system. The exported data populates the master database.
The system further includes a software application or other data entry tool 32 to input data and information into at least one feeder database 30. Data may be entered, for example, by importing databases associated with retailers, crop consultants, vendors, growers, universities, research institutions, or the government. Additionally, a contributor may directly enter information via a computer, cell phone, smart phone, tablet computer, or other device linkable via a telecommunications network to the feeder database. Also, data-gathering devices 38 in the field that measure status characteristics (such as rainfall amounts, atmospheric temperature, canopy temperature, and the like) may periodically and automatically upload information into the feeder database. The feeder databases 30 are accessed through the software interface 32 allowing a particular user (such as a retailer 34a, crop consultant 34b, landowner 34c, grower 34d, or other data contributor 34e) to enter and/or update information provided by the user to a particular feeder database 30.
A processor 40 is connected to and receives data from the master database for the purpose of conducting the regression analysis to produce reports and analyses concerning historical trends, comparative analysis, and predictive growth models.

Finally, a monitor, smartphone, cell phone, tablet PC, or other display device 42 is provided for communicating to the requestor the reports and analyses conducted by the processor. The display device 42 may be integrated into the software application or data entry tool 32, or it may be viewable independently from the data entry site. For example, a grower 34d may be able to enter data through the software application 32, but the results of the analysis performed by the processor 40 may only be displayed on a display device 42 accessible by the grower's crop consultant 34b.

### D. Conclusions

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and is capable of changes or modifications within the scope of the teachings as expressed herein, commensurate with the skill and/or knowledge of a person having ordinary skill in the relevant art. The embodiments described hereinabove are further intended to explain certain modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein. Any section headings herein are provided only for consistency with the suggestions of 37 C.F.R. §1.77 or otherwise to provide organizational queues. These headings shall not limit or characterize the invention(s) set forth herein.

I claim:

1) A process for data management and use in portfolio analysis for agricultural production businesses comprising:
a) identifying a data contributor who has access to information about agricultural production, or about factors that do or may influence agricultural production;
b) creating a plurality of feeder databases, where each feeder database is associated with at least one data contributor;
c) collecting data from at least one data contributor comprising observational data about inputs and results from at least one entity's commercial production efforts;
d) tagging data with an indication of the source type of such data;
e) identifying data related to or identifying personal information;
f) maintaining the data collected from the data contributor in the feeder database associated with the data contributor;
g) linking the plurality of feeder databases to a master database, in a manner such that a subset of information added to the feeder database populates forward into the master database, wherein the subset of information does not include personal information;
h) receiving a request for data analysis from a requestor associated with a first entity engaged in agricultural production, about which first entity at least some observational data from such first entity's prior agricultural production efforts is contained in a feeder database;
i) receiving a plurality of inputs from the requestor, the plurality of inputs comprising a crop to be analyzed, a yield goal, and afield having defined soil characteristics;
j) querying the master database to identify other entities for whom data in the master database reflects environmental characteristics and management techniques similar to those reflected in information associated with the first entity to create a group called a cohort, said data in the master database known as a cohort subset;
k) analyzing the information in the first entity's observational data and the cohort subset to determine an optimal crop variety bundle for use in the field; and
l) displaying the resulting optimal crop variety bundle and a risk curve depicting various yield possibilities and corresponding risk to the first entity.

2) The process of claim 1, further comprising collecting data from at least one data contributor comprising publicly available data about agricultural production or factors that do or may influence agricultural production.

3) The process of claim 1, further comprising collecting data from at least one data contributor comprising vendor data about particular crop varieties.

4) The process of claim 1, further comprising providing the data contributor with access to the database associated with the contributor.

5) The process of claim 4, comprising, after analyzing information in the first entity's observational data, reporting the request and the analysis to the contributor associated with the feeder database maintaining the first entity's observational data.

6) The process of claim 1, wherein the subset of information populated into the master database comprises information about environmental characteristics of geographical areas regarding which data is present in the subset, and information about agricultural management techniques of geographical areas regarding which data is present in the subset.

7) The process of claim 6, wherein the subset of information populated into the master database further comprises the indication of the source type of the data.

8) The process of claim 1, wherein the inputs from first entity further comprise an indication of crop varieties not to be included in the optimal crop variety bundle.

9) The process of claim 1, further comprising after querying the master database, determining whether the population of other entities in the cohort subset is so small that the sample size results in a high chance of error, is statistically uncertain or insignificant, or would result in a response revealing sufficient information to identify the other entities to the first entity, and if so, either
a) broadening the scope of the cohort subset, whereby the number of other entities is increased; or
b) requesting a new request for data analysis having broader inputs.

10) The process of claim 1 further comprising, after determining an optimal crop variety bundle, removing from the bundle any crop variety for which an amount of seed or acreage planted included in the bundle is below a minimal amount.

11) The process of claim 10, where the inputs from the requestor further comprise a minimal amount.

12) The process of claim 10 further comprising reapportioning seed or acreage allocated to crop varieties below the minimal amount to crop varieties remaining in the optimal crop variety bundle.

13) The process of claim 1 further comprising, after determining the optimal crop variety bundle, allocating crop varieties within the optimal crop variety bundle among a plurality of maturity groups.

14) The process of claim 1 further comprising adding, to the feeder database containing the observational data of the first entity, information related to the optimal crop variety bundle.

15) The process of claim 1 wherein within the analyzing step data having a source type of observational data is weighted more heavily than other data of other sources types.

16) The process of claim 1, wherein during the analysis data associated the first entity is weighted more heavily than other observational data.

17) The process of claim 1, wherein during the analysis data in closer geographic proximity to the field identified in the inputs is weighted more heavily than data farther from the field.

18) The process of claim 1, wherein data related to average crop yields is weighted more heavily than data related to abnormally high or low yields.

19) The process of claim 1, where the inputs further comprise a risk tolerance level associated with the first entity.

20) A process for data management and use in portfolio analysis for agricultural production businesses comprising:
a) identifying a data contributor who has access to information about agricultural production, or about factors that do or may influence agricultural production;
b) creating a plurality of feeder databases, where each feeder database is associated with at least one data contributor;
c) collecting data from at least one data contributor comprising observational data about inputs and results from at least one entity's commercial production efforts;
d) collecting data from at least one data contributor comprising publicly available data about agricultural production or factors that do or may influence agricultural production;
e) tagging data with an indication of the source type of such data;
f) identifying data related to or identifying personal information;
g) maintaining the data collected from the data contributor in the feeder database associated with the data contributor;
h) providing the data contributor with access to the database associated with the contributor;
i) linking the plurality of feeder databases to a master database, in a manner such that a subset of information added to the feeder database populates forward into the master database, wherein the subset of information comprises information about environmental characteristics of geographical areas regarding which data is present in the subset, and information about agricultural management techniques of geographical areas regarding which data is present in the subset, but does not include personal information;
j) receiving a request for data analysis from a requestor associated with a first entity engaged in agricultural production, about which first entity at least some observational data from such first entity's prior agricultural production efforts is contained in a feeder database;
k) receiving a plurality of inputs from the requestor, the plurality of inputs comprising a crop to be analyzed, a yield goal, and a field having defined soil characteristics;
l) querying the master database to identify other entities for whom data in the master database reflects environmental characteristics and management techniques similar to those reflected in information associated with the first entity to create a group called a cohort, said data in the master database known as a cohort subset;
m) determining whether the population of other entities in the cohort subset is so small that the sample size results in a high chance of error, is statistically uncertain or insignificant, or would result in a response revealing sufficient information to identify the other entities to the first entity, and if so, either
i) broadening the scope of the cohort subset, whereby the number of other entities is increased; or
ii) requesting a new request for data analysis having broader inputs and repeating the process beginning at the step of receiving inputs;
n) analyzing the information in the first entity's observational data and the cohort subset to determine an optimal crop variety bundle for use in the field;
o) removing from the bundle any crop variety for which an amount of seed or acreage planted included in the bundle is below a minimal amount;
p) reapportioning seed or acreage allocated to crop varieties below the minimal amount to crop varieties remaining in the optimal crop variety bundle;
q) allocating crop varieties within the optimal crop variety bundle among a plurality of maturity groups;
r) displaying the resulting optimal crop variety bundle and a risk curve depicting various yield possibilities and corresponding risk to the first entity;
s) adding, to the feeder database containing the observational data of the first entity, information related to the optimal crop variety bundle;
t) reporting the request and the analysis to the contributor associated with the feeder database maintaining the first entity's observational data.

21) A system for data management and use in portfolio analysis for agricultural production businesses comprising:
a) at least one feeder database maintaining information comprising observational data, the observational data comprising personal information;
b) a master database linked to at least one feeder database such that a subset of information, the subset excluding personal information, populates the master database;
c) a data entry tool linked to at least one feeder database for submitting information to the feeder database;
d) a processor linked to and receiving data from the master database and configured to conduct an analysis of some or all of the subset of information populating the master database; and
e) a display device linked to the processor for displaying to a user a result of the analysis.

22) The system of claim 21, further comprising a data-gathering device linked to at least one feeder database to transmit status characteristics.

23) The system of claim 21 further comprising at least one feeder database maintaining information comprising publicly available data.

24) The system of claim 21 further comprising at least one feeder database maintaining information comprising vendor data.
